(19) United States
(12) Patent Application Publication
(10) Pub. No.: US 2013/0076556 A1
(43) Pub. Date: Mar. 28, 2013

(54) Active differential reflectometry

(71) Applicants: Kevin A. Boulais, La Plata, MD (US); Edward R. Huber, Faulkner, MD (US); Eric B. McDaniel, Fredericksburg, VA (US); Jennifer K. Roames, Fredericksburg, MD (US); Nancy A. Breaux, King George, VA (US); John Thaddeus Seeberger, Newport News, VA (US)

(72) Inventors: Kevin A. Boulais, La Plata, MD (US); Edward R. Huber, Faulkner, MD (US); Eric B. McDaniel, Fredericksburg, VA (US); Jennifer K. Roames, Fredericksburg, MD (US); Nancy A. Breaux, King George, VA (US); John Thaddeus Seeberger, Newport News, VA (US)

(73) Assignee: United States Government, as represented by the Secretary of the Navy, Arlington, VA (US)

(21) Appl. No.: 13/317,039

(22) Filed: Sep. 26, 2011

(51) Int. Cl. G01S 13/89

(52) U.S. Cl. 342/22; 342/176

(57) ABSTRACT

A millimeter wave method and apparatus for detecting objects on humans, for example, that might be hidden, for example, under the human's clothing includes an active w-band radiation source to illuminate the human subject; a diffuser on the active illumination source; a receiver to acquire an active mode and a passive mode image; apparatus and methods to minimize background environmental millimeter waves; and a device to form and display a differential image. The resulting differential image may show contraband at high resolution while avoiding display of the human anatomy.

### STATEMENT OF GOVERNMENT INTEREST

The invention described herein may be manufactured and used by or for the Government of the United States of America for governmental purposes without the payment of any royalties thereon or therefor.

### BACKGROUND OF THE INVENTION

(1) Field of the Invention

The invention relates to imaging apparatus and methods and, more particularly, to a millimeter wave apparatus and method for detecting hidden objects such as contraband hidden under human clothing.

(2) Description of the Prior Art

The millimeter wavelength region of the electromagnetic spectrum has several characteristics desirable for screening people for concealed weapons, explosives, containers of liquid, and other threats. These characteristics include high resolution capability due to short wavelength, transparency through most types of clothing, opaqueness to the human body, and continuous emission by the human body as part of thermal blackbody radiation.

Passive millimeter wave image systems are already in use for detection of hidden objects under clothing. High resolution images resulting in excellent concealed object detectability can be achieved using this technique. Despite low signal levels, commercially available systems are able to acquire images at video rates. The passive approach also has the advantage of not irradiating the subjects that are being scanned with any form of radiation. Safety concerns of the general public about low level millimeter wave radiation, while unfounded, are nevertheless mitigated by use of a passive system.

Active millimeter wave imaging systems, also already in use, utilize similar imaging technology to the passive systems, but benefit from scene illumination at the same wavelength. This results in highly improved signal to noise ratio and therefore clearer images and even higher frame rates. The concern for active mode is lower acceptance by the general public. In reality, the required illumination power for this type of imaging is orders of magnitude below exposure limits as determined by the federal government. As it is non-ionizing radiation, there are no known or expected health concerns for exposure levels below the thresholds established by the government.

High end systems of both active and passive technologies suffer from privacy issues stemming from their capability to image the human body through clothing at high spatial resolution. Current systems have demonstrated capability to image anatomical details considered private. Despite claims by manufacturers that recording of the images is not possible, the recent event where images of an actor were printed and distributed among Heathrow airport staff show that the images can be recorded and can be accessed. Even if such software security holes are patched, the on-screen images could still simply be photographed by a cell-phone camera or other discreet imaging device. The lack of a recording ability is a problem in itself, as no record of the screening can be preserved for use as evidence that probable cause existed for further screening. Even more disturbing are the recent claims that such imaging violates child pornography laws both in the UK and European Union. Such claims have blocked implementation of the imaging systems in France and threaten to force the removal of such imaging systems elsewhere.

One current technique to mitigate this privacy problem is using reduced resolution or blurring of the entire human image so as to blur out the anatomical details of concern. A related technique is using a computerized human outline recognition system to determine the exact location or regions considered private, and then blurring or completely blocking of these areas only. Both of the blurring approaches have the tremendous disadvantage of giving up the resolution, and therefore detectability, of smaller objects that makes the millimeter wave systems so useful. The total blocking of private regions technique gives up all ability to detect objects that may be intentionally hidden in these regions. In fact, a recent attempted terrorist attacker, the so-called underwear bomber of Christmas day 2009, showed that terrorists can and will exploit the vulnerability imposed by blurring or removing private areas from the image.

Another technique used to mitigate the privacy problem is using a computerized image recognition algorithm to identify the threat objects and overlay an image or highlight of the threat object onto the silhouette or image of the person from a separate visible light camera. This approach is highly dependent on a computerized algorithm which may or may not be able to distinguish an object that is a threat from shadows, other body features, or even the very anatomical details the technique is trying to obscure. This removes the human operator from being able to see the live millimeter wave image, despite the fact that humans have much better image recognition skills than computer algorithms, especially in noisy, real-world scenarios. Once a threat condition is determined by the computer, the algorithm would also have to be able to reproduce the shape or outline of the threat object accurately enough for the human operator to recognize it as a threat, which the algorithm may or may not be able to do in a real-world environment, or the operator may ignore the flagged threat. In addition, the lack of a live millimeter wave image could cause a malfunctioning camera to remain in operation, since the only effect that the operator could see would be a lack of detected threats. Thus, without a human operator viewing a live image, a high false positive rate, or even worse, missed threat objects, could result.

There is a need for apparatus and methods for imaging for concealed items with high resolution and reliable threat detection while eliminating the privacy concern of conventional methods.

### SUMMARY OF THE INVENTION

According to one aspect of the current invention, a differential reflectometry device comprises a w-band radiation source adapted to emit w-band radiation onto a subject; a camera adapted to acquire a passive mode image and an active mode image of the subject, wherein the active mode image is acquired when the w-band radiation source is emitting w-band radiation and the passive mode image is acquired when the w-band radiation source is not emitting w-band radiation; and an image processor adapted to create a difference image by taking the difference of the passive mode image and the active mode image.

According to another aspect of the current invention, a method for detecting an object comprises emitting w-band radiation from a w-band radiation source onto a subject; acquiring a passive mode image and an active mode image of the subject with a camera, wherein the active mode image is acquired when the w-band radiation source is emitting w-band radiation and the passive mode image is acquired when the w-band radiation source is not emitting w-band radiation; and creating a difference image with an image processor by taking the difference of the passive mode image and the active mode image.

According to a further aspect of the current invention, a method for detecting a concealed object carried by a human subject comprises minimizing millimeter waves from a background environment surrounding the human subject; emitting diffuse w-band radiation from a w-band radiation source onto the human subject; acquiring a passive mode image and an active mode image of the human subject with a camera, wherein the active mode image is acquired when the w-band radiation source is emitting w-band radiation and the passive mode image is acquired when the w-band radiation source is not emitting w-band radiation; creating a difference image with an image processor by taking the difference of the passive mode image and the active mode image; and detecting a high contrast signal in the difference image, the high contrast signal corresponding to the presence of a concealed object.

The above and other features of the invention, including various novel details of construction and combinations of parts, will now be more particularly described with reference to the accompanying drawings and pointed out in the claims. It will be understood that the particular assembly embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

Reference is made to the accompanying drawings in which is shown an illustrative embodiment of the invention, from which its novel features and advantages will be apparent, wherein corresponding reference characters indicate corresponding parts throughout the several views of the drawings and wherein:

FIG. 1 is an exemplary setup of an active differential reflectometry device according to an embodiment of the current invention; and

FIG. 2A shows experimental results of a normalized passive w-band image of a person with contraband;

FIG. 2B shows experimental results of a normalized active w-band image of the person of FIG. 2A; and

FIG. 2C shows experimental results of a normalized differential of the image of FIG. 2A and FIG. 2B, showing the contraband but no discernable image of the human form.

### DETAILED DESCRIPTION OF THE INVENTION

Broadly, exemplary embodiments of the current invention provides a millimeter wave method and apparatus for detecting objects on humans, for example, that might be hidden, for example, under the human's clothing. The current invention includes an active w-band radiation source to illuminate the human subject; a diffuser on the active illumination source; a receiver to acquire an active mode and a passive mode image; apparatus and methods to minimize background environmental millimeter waves; and a device to form and display a differential image. The resulting differential image may show contraband at high resolution while avoiding display of the human anatomy.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a floating point gate array (FPGA) or other related component.

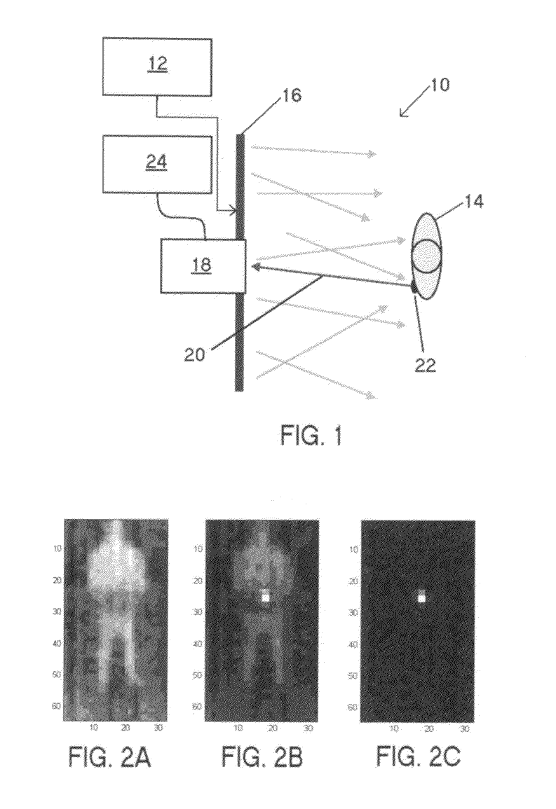

Referring now to the drawings, and more particularly to FIG. 1, a reflectometry device 10 may include an active w-band radiation source 12 adapted to illuminate a subject 14. The human body mimics a blackbody source closely as it has an emissivity of about 0.98 regardless of skin tone. This means that human skin is a good emitter of radiation. By Kirchhoff's law of thermal radiation, which states that at thermal equilibrium, the emissivity of a body or surface equals its absorptivity, this also means that human skin is a good absorber. This is also somewhat true for absorption/emission mechanisms other than blackbody.

The human body is a source of emission in the w-band and thus is also a good absorber of w-band radiation. Therefore any w-band radiation directed at the human body will mostly be absorbed and little will be reflected. This is one aspect of the current invention, as contrast may be produced for hidden objects using an active w-band radiation source, but not of the human form. For example, the active illumination radiation may be reflected from hidden objects 22, turning the objects from dark to light, but may not be reflected from the human body, thus producing no change for skin. This is shown by the reflected arrow 20 in FIG. 1. Metal objects will reflect w-band particularly well due to the interaction between the w-band and the electromagnetic properties of a metal.

A diffuser 16 may be used with the active w-band radiation source 12 to soften and direct the w-band radiation so that it emanates from multiple directions, as indicated by the arrows in FIG. 1. Typical w-band radiation sources are single point sources of coherent radiation. This presents issues for imaging applications, as the point source nature allows for very harsh shadows and specular reflections that may cause light to be completely reflected away from a camera 18. A specular reflection, for example, would be like the reflection of a light beam off a shiny piece of metal. No light comes back to the camera unless the full beam is reflected directly back into the camera. In the current invention, no reflection of the illumination back into the camera means the object disappears in the difference image, as discussed below. The diffuser 16 can be used to disperse and randomize the paths of rays of w-band radiation, ‘softening’ the illumination in a manner similar to a soft box used in photography. In some embodiments, multiple w-band radiation sources 12 may placed at different angles to further enhance the effectiveness of the illumination. In some cases, the w-band radiation source itself can produce diffuse w-band radiation.

As shown in FIG. 2A and 2B, respectively, a passive mode image and an active mode image may be acquired by the reflectometry device 10. In some embodiments, the w-band radiation source 12 may be pulsed, switching on and off, at video rate for example, in a square wave manner. The video rate may be, for example, from about 5 to about 240 pulses per second.

An active mode image may be acquired during the on-time of a pulse, while the passive mode image may be acquired during the next off-time between pulses. The duty cycle of the square wave could be adjusted if a longer acquisition time is required for the passive mode images. One intention of the fast duty rate is so imaging can be accomplished on a moving subject and in real time. For static images, such high frame rates may not be necessary.

To acquire good signal to noise signals, the current invention may minimize millimeter waves from the surrounding background environment. Millimeter waves from the surrounding environment can reflect off of the hidden objects, resulting in loss of contrast from the human body, especially in passive mode. In order to reduce this effect, sources of environmental millimeter waves should be reduced, and objects which can reflect off them should also be reduced. The millimeter wave camera can be used to determine if any spurious sources or reflections are present. Background objects which are reflecting millimeter waves into the scene or back at the camera can be removed, or covered with a millimeter wave absorber material. Emitting objects can be removed or cooled to reduce millimeter wave emissions. Alternatively, a special portal, room, corridor, or curtained-off area could be constructed with the walls or curtains made of or covered with millimeter wave absorber material. The walls could be cooled if ambient temperature results in too much millimeter wave emission from the walls.

Once the passive mode image (FIG. 2A) and the active mode image (FIG. 2B) are captured by the camera 18, an image processor 24 may be used to create a difference image (FIG. 2C). The difference image may be formed by subtraction of the passive image from the active image (or vice versa). Since the human body absorbs most millimeter wave radiation that is incident on it, very little will be reflected back to the camera during the active image. The radiation picked up by the active image human body will thus be only what the body is already emitting—which is mostly the same as in the passive image. It follows that the human body will appear mostly the same in the passive and active images. In the difference image, therefore, the human body will disappear, anatomical details and all. This difference image may be displayed to a user of the reflectometry device for review. In some embodiments, a computer algorithm may be developed for detecting concealed objects automatically, without requiring the user to continuously monitor the difference image for each subject passing through the device.

Concealed objects, on the other hand, may appear bright in the active image and dark in the passive image. Their contrast will therefore increase when the passive image is subtracted from the active image. Thus the final image will show threat objects with very high intensity, while the body will disappear. The acquisition and processing could occur at high frame rates, enabling the difference image to be viewed live by the operator. Since anatomical details are removed from this image, it can be recorded and saved for documentation. If some faint image of the human subject remains, a threshold function or other small image processing adjustment can be applied to remove it.

A visible recording of the scene can be accomplished at the same rate as the w-band recording to correlate an object to its carrier for identification purposes. This can be extended to the X-ray portion of the electromagnetic spectrum. Typically, two images are obtained (one active and one passive), however, more images may be obtained to provide higher levels of sophistication. For example, one active and two passive images may be acquired, or three active and three passive images may be acquired.

It should be noted that FIG. 2A-2C show low resolution images due to camera limitations at the time the data was acquired. Modern cameras may have improved resolution.

It will be understood that many additional changes in the details, materials, steps and arrangement of parts, which have been herein described and illustrated in order to explain the nature of the invention, may be made by those skilled in the art within the principle and scope of the invention as expressed in the appended claims.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims.

What is claimed is:

1. A differential reflectometry device comprising:
a w-band radiation source adapted to emit w-band radiation onto a subject;
a camera adapted to acquire a passive mode image and an active mode image of the subject, wherein the active mode image is acquired when the w-band radiation source is emitting w-band radiation and the passive mode image is acquired when the w-band radiation source is not emitting w-band radiation; and
an image processor adapted to create a difference image by taking the difference of the passive mode image and the active mode image.

2. The differential reflectometry device of claim 1, wherein the w-band radiation source is adapted to emit diffuse w-band radiation.

3. The differential reflectometry device of claim 2, further comprising a diffuser to diffuse w-band radiation emitted from the w-band radiation source.

4. The differential reflectometry device of claim 1, wherein the w-band radiation source is pulsed on and off to simultaneous acquire the active mode image, when the w-band radiation source is pulsed on, and the passive mode image, when the w-band radiation source is pulsed off.

5. The differential reflectometry device of claim 1, further comprising wave absorbing material adapted to remove background millimeter waves from a background environment surrounding the subject.

6. The differential reflectometry device of claim 1, wherein the difference image does not include a discernable human form.

7. A method for detecting an object, comprising:
emitting w-band radiation from a w-band radiation source onto a subject;
acquiring a passive mode image and an active mode image of the subject with a camera, wherein the active mode image is acquired when the w-band radiation source is emitting w-band radiation and the passive mode image is acquired when the w-band radiation source is not emitting w-band radiation; and
creating a difference image with an image processor by taking the difference of the passive mode image and the active mode image.

8. The method of claim 7, further comprising diffusing the w-band radiation from the radiation source.

9. The method of claim 8, wherein a diffuser is used to diffuse the w-band radiation.

10. The method of claim 8, wherein the w-band radiation source provides diffuse w-band radiation.

11. The method of claim 7, further comprising pulsing the w-band radiation source on and off.

12. The method of claim 11, wherein the pulsing of the w-band radiation source is done in a square wave manner.

13. The method of claim 11, wherein the camera acquires the passive mode image when the w-band radiation source is off and the camera acquires the active mode image when the w-band radiation source is on.

14. The method of claim 7, further comprising minimizing millimeter waves from a background environment surrounding the subject.

15. The method of claim 7, further comprising displaying the difference image to a user.

16. A method for detecting a concealed object carried by a human subject, comprising:
minimizing millimeter waves from a background environment surrounding the human subject;
emitting diffuse w-band radiation from a w-band radiation source onto the human subject;
acquiring a passive mode image and an active mode image of the human subject with a camera, wherein the active mode image is acquired when the w-band radiation source is emitting w-band radiation and the passive mode image is acquired when the w-band radiation source is not emitting w-band radiation;
creating a difference image with an image processor by taking the difference of the passive mode image and the active mode image; and
detecting a high contrast signal in the difference image, the high contrast signal corresponding to the presence of a concealed object.

17. The method of claim 16, further comprising pulsing the w-band radiation source on and off.

18. The method of claim 17, wherein the camera acquires the passive mode image when the w-band radiation source is off and the camera acquires the active mode image when the w-band radiation source is on.

19. The method of claim 16, further comprising acquiring a visible recording of the human subject at the same time as acquiring the difference image.

20. The method of claim 16, further comprising placing multiple w-band radiation sources at different angles relative to the human subject.
